(19) United States
(12) Patent Application Publication
(10) Pub. No.: US 2026/0038521 A1
(43) Pub. Date: Feb. 5, 2026

(54) SCENE AUDIO SIGNAL ENCODING METHOD AND APPARATUS

(71) Applicant: HUAWEI TECHNOLOGIES CO., LTD., Shenzhen (CN)

(72) Inventors: Shuai Liu, Beijing (CN); Yuan Gao, Beijing (CN); Bingyin Xia, Beijing (CN); Zhe Wang, Beijing (CN)

(73) Assignee: HUAWEI TECHNOLOGIES CO., LTD., Shenzhen (CN)

(21) Appl. No.: 19/355,810

(22) Filed: Oct. 10, 2025

Related U.S. Application Data
(63) Continuation of application No. PCT/CN2024/086390, filed on Apr. 7, 2024.

(30) Foreign Application Priority Data
Apr. 13, 2023 (CN) 202310436966.9

(51) Int. Cl. G10L 19/008

(52) U.S. Cl. CPC G10L 19/008

(57) ABSTRACT

This application provides a scene audio signal encoding method and apparatus. The scene audio signal encoding method in this application includes: obtaining a to-be-encoded scene audio signal including audio signals of C channels, and C is a positive integer; performing transient detection on M channels, among the C channels, that need transient detection, to obtain transient identifiers of the M channels, where each transient identifier indicates whether a corresponding channel includes a transient signal, and 1≤M≤C; and encoding the transient identifiers of the M channels and the scene audio signal to obtain a bitstream. In this application, a transient signal in the scene audio signal can be processed, to improve quality of a reconstructed audio signal and auditory experience of a user.

### CROSS-REFERENCE TO RELATED APPLICATIONS

This application is a continuation of International Application No. PCT/CN2024/086390, filed on Apr. 7, 2024, which claims priority to Chinese Patent Application No. 202310436966.9, filed on Apr. 13, 2023. The disclosures of the aforementioned applications are hereby incorporated by reference in their entireties.

### TECHNICAL FIELD

This application relates to audio encoding and decoding technologies, and in particular, to a scene audio signal encoding method and apparatus.

### BACKGROUND

A three-dimensional audio technology is an audio technology for obtaining, processing, transmitting, rendering, and playing back sound events and three-dimensional sound field information in the real world through a computer, signal processing, or the like. Three-dimensional audio enables sound to have a strong sense of space, envelopment, and immersion, and provides people with extraordinary “immersive” auditory experience. A higher-order ambisonics (HOA) technology has the following characteristics: Recording, encoding, and playback stages are irrelevant to a speaker layout, and data in an HOA format is rotatably played back. Therefore, the HOA technology has higher flexibility in three-dimensional audio playback, and has gained more extensive attention and research.

In the HOA technology, a large amount of data is needed for recording more detailed information of a sound scene, to achieve better auditory effect of audio. Scene-based three-dimensional audio signal sampling and storage are more conducive to storage and transmission of spatial information of an audio signal. However, a quantity of channels corresponding to an N^{th}-order HOA signal is (N+1)². As an HOA order quantity increases, more data is generated. A large amount of data causes difficulty in transmission and storage. Therefore, the HOA signal needs to be encoded and decoded.

In the related art, some channels may be encoded and decoded to reduce a bitstream size and improve encoding and decoding efficiency. However, processing of a transient signal is not considered, leading to degradation of quality of a reconstructed audio signal and affecting auditory experience of a user.

### SUMMARY

This application provides a scene audio signal encoding method and apparatus, to process a transient signal in a scene audio signal, to improve quality of a reconstructed audio signal and auditory experience of a user.

According to a first aspect, this application provides a scene audio signal encoding method. The method includes: obtaining a to-be-encoded scene audio signal, where the scene audio signal includes audio signals of C channels, and C is a positive integer; performing transient detection on M channels, among the C channels, that need transient detection, to obtain transient identifiers of the M channels, where the transient identifier indicates whether a corresponding channel includes a transient signal, and 1≤M≤C; and encoding the transient identifiers of the M channels and the scene audio signal to obtain a bitstream.

In this embodiment of this application, an encoder performs transient detection on the selected M channels, and writes a transient detection result (a transient detection identifier) into the bitstream, for a decoder to perform transient recovery. In this way, a transient signal in the scene audio signal can be processed, to improve quality of a reconstructed audio signal and auditory experience of a user.

The scene audio signal is an information carrier that carries spatial location information of a sound source in a sound field, and describes a sound field of a listener in space. The scene audio signal may include audio signals of C channels, where C is a positive integer.

In an embodiment, the scene audio signal may be an HOA signal, and the HOA signal may be an N^{th}-order HOA signal including audio signals of (N+1)² channels. In this case, C=(N+1)².

Transient is also referred to as a transitory state. Energy of an audio signal of one or more channels among a plurality of channels of the scene audio signal may suddenly change. For example, if energy suddenly increases at a specific moment, a channel with the sudden change may be considered as a channel with transient (or a transitory state). A process of determining whether a channel includes a transient signal may be referred to as transient detection.

The M channels that need transient detection are M channels, among the C channels of the scene audio signal, on which transient detection needs to be performed. M is a positive integer greater than or equal to 1 and less than or equal to C. To be specific, M being the minimum value 1 indicates that only one of the C channels of the scene audio signal needs transient detection, M being the maximum value C indicates that all of the C channels of the scene audio signal need transient detection, and M being any value between 1 and C indicates that some of the C channels of the scene audio signal need transient detection.

In an embodiment, the encoder may determine, in a preset manner, the M channels that need transient detection.

For example, a transient detection table is pre-generated, where 1 is written into a corresponding table for a channel among the C channels that needs transient detection, and 0 is written into a corresponding table for a channel that does not need transient detection. The encoder may obtain the M channels by querying the transient detection table.

For example, if the transient detection table is generated based on a horizontal plane and directivity of HOA channels, 1 is written for W, Y, X, V, U, Q and P channels, and 0 is written for other channels.

For example, M channels may be specified based on a user configuration; or it may be specified that a quantity of channels included in a Kth order is M channels, where K is less than N.

After determining the M channels that need transient detection, the encoder may perform transient detection on the M channels one by one to obtain respective transient detection results of the M channels, and then assign transient identifiers to corresponding channels based on the transient detection results.

In an embodiment, the transient identifier may be represented by a 1-bit syntax element. For example, 1 indicates that a transient signal exists, and θ indicates that no transient signal exists. If a transient detection result of a channel is that the channel includes a transient signal, a transient identifier of the channel is set to 1. If a transient detection result of a channel is that the channel includes no transient signal, a transient identifier of the channel is set to 0.

In an embodiment, if M=1, the encoder may perform transient detection on one of the C channels in the scene audio signal. For the one of the C channels, a fixed channel may be selected. For example, one channel that needs transient detection is the W channel (to be specific, a channel 1 (also referred to as the 1^{st} channel) among the foregoing (N+1)² channels). The encoder may calculate an energy envelope of the W channel; compare a ratio of an envelope peak value to an envelope trough value with a first threshold; and if the ratio is greater than the first threshold, determine that the W channel includes a transient signal; or otherwise, determine that the W channel includes no transient signal.

The first threshold may be preset, for example, 0.1. A value of the first threshold is not limited in this embodiment of this application.

The high-frequency signal and the low-frequency signal may be distinguished through comparison with a preset second threshold. For example, it is determined that a signal on a frequency band greater than T kHz (the second threshold) in the W channel is a high-frequency signal, and it is determined that a signal on a frequency band less than or equal to T kHz in the W channel is a low-frequency signal. Energy of a signal may be calculated by using a method of a square of an amplitude. For example, the second threshold may be 4 kHz. This is not limited in this embodiment of this application.

After obtaining a transient detection result of the W channel, the encoder obtains a transient identifier of the W channel. In an embodiment, the transient identifier of the W channel may be used as transient identifiers of C channels of a current frame in the scene audio signal. To be specific, if the W channel includes a transient signal, all of the C channels include transient signals; or if the W channel includes no transient signal, none of the C channels includes a transient signal.

In an embodiment, if M=C, the encoder may perform transient detection on all of the C channels in the scene audio signal to obtain a transient identifier of each channel. For a transient detection method for any channel, refer to the foregoing transient detection method for the W channel. Details are not described herein again.

In an embodiment, if 1<M<C, the encoder may perform transient detection on some of the C channels in the scene audio signal to obtain transient identifiers of the channels. A channel that does not undergo transient detection is considered as including no transient signal. For a transient detection method for any channel, refer to the foregoing transient detection method for the W channel. Details are not described herein again.

In this embodiment of this application, the encoder encodes the scene audio signal by using at least two encoding methods, where the at least two encoding methods include direct encoding. The direct encoding may be an encoding scheme for encoding a signal.

In an embodiment, the C channels in the scene audio signal may be divided into at least two types of channels, where direct encoding is performed on a first channel, and other encoding is performed on a second channel.

The other encoding may include spatial encoding and decorrelation. For the spatial encoding, refer to an embodiment shown in FIG. 2a. Spatial encoding information (also referred to as attribute information of a target virtual speaker) is extracted based on the to-be-encoded scene audio signal, and the spatial encoding information is encoded into a bitstream. The decorrelation may be time-domain decorrelation or frequency-domain decorrelation, and a delay and a phase of a decorrelation signal is adjusted by using an all-pass filter.

The encoder may encode the scene audio signal by using the foregoing method, including: performing direct encoding on the first channel, and performing spatial encoding on the second channel; or performing direct encoding on the first channel, and performing decorrelation on a third channel; or performing direct encoding on the first channel, performing spatial encoding on the second channel, and performing decorrelation on a third channel.

In addition, the encoder further writes the transient identifiers of the M channels into the bitstream, for the decoder to perform transient recovery.

According to a second aspect, this application provides a scene audio signal encoding apparatus. The apparatus includes: an obtaining module, configured to obtain a to-be-encoded scene audio signal, where the scene audio signal includes audio signals of C channels, and C is a positive integer; a transient detection module, configured to perform transient detection on M channels, among the C channels, that need transient detection, to obtain transient identifiers of the M channels, where the transient identifier indicates whether a corresponding channel includes a transient signal, and 1≤M≤C; and an encoding module, configured to encode the transient identifiers of the M channels and the scene audio signal to obtain a bitstream.

In an embodiment, when M=1, the M channels are a W channel among the C channels; or when 1<M<C, the M channels are preset.

In an embodiment, the transient detection module is configured to: obtain an energy difference between a high-frequency signal and a low-frequency signal of a target channel, where the high-frequency signal is a signal with a frequency greater than a first threshold among audio signals of the target channel, the low-frequency signal is a signal with a frequency less than or equal to the first threshold among the audio signals of the target channel, and the target channel is any one of the M channels; and when the energy difference is greater than a second threshold, assign a first transient identifier to the target channel, where the first transient identifier indicates that the target channel includes a transient signal; or when the energy difference is less than or equal to a second threshold, assign a second transient identifier to the target channel, where the second transient identifier indicates that the target channel includes no transient signal.

In an embodiment, the scene audio signal is encoded by using at least two encoding methods, and the at least two encoding methods include direct encoding, and further include spatial encoding and/or decorrelation.

In an embodiment, the encoding module is configured to: perform direct encoding on a first channel, and perform spatial encoding on a second channel; or perform direct encoding on a first channel, and perform decorrelation on a third channel; or perform direct encoding on a first channel, perform spatial encoding on a second channel, and perform decorrelation on a third channel, where the first channel, the second channel, or the third channel is a type of channel among the C channels.

According to a third aspect, this application provides a bitstream generation method, where a bitstream is generated according to the method according to any one of the embodiments of the first aspect.

According to a fourth aspect, this application provides an electronic device, including: one or more processors; and a memory, configured to store one or more programs. When the one or more programs are executed by the one or more processors, the one or more processors are enabled to implement the method according to any one of the embodiments of the first aspect.

According to a fifth aspect, this application provides a chip, including one or more interface circuits and one or more processors. The interface circuit is configured to receive a signal from a memory of an electronic device, and send the signal to the processor. The signal includes computer instructions stored in the memory. When the processor executes the computer instructions, the electronic device is enabled to perform the method according to any one of the embodiments of the first aspect.

According to a sixth aspect, this application provides a computer-readable storage medium. The computer-readable storage medium stores a computer program. When the computer program is run on a computer or a processor, the computer or the processor is enabled to perform the method according to any one of the embodiments of the first aspect.

According to a seventh aspect, this application provides a computer program product. The computer program product includes computer program code. When the computer program code is run on a computer, the computer is enabled to perform the method according to any one of the embodiments of the first aspect.

According to an eighth aspect, this application provides a bitstream storage apparatus. The apparatus includes a receiver and at least one storage medium. The receiver is configured to receive a bitstream. The at least one storage medium is configured to store the bitstream. The bitstream is generated according to the method according to any one of the embodiments of the first aspect.

According to a ninth aspect, this application provides a bitstream transmission apparatus. The apparatus includes a transmitter and at least one storage medium. The at least one storage medium is configured to store a bitstream. The bitstream is generated according to the method according to any one of the embodiments of the first aspect. The transmitter is configured to obtain the bitstream from the storage medium, and send the bitstream to a terminal-side device through a transmission medium.

According to a tenth aspect, this application provides a bitstream delivery system. The system includes: at least one storage medium, configured to store at least one bitstream, where the at least one bitstream is generated according to the method according to any one of the embodiments of the first aspect; and a streaming media device, configured to obtain the bitstream from the at least one storage medium, and send the bitstream to a terminal-side device, where the streaming media device includes a content server or a content delivery server.

### BRIEF DESCRIPTION OF DRAWINGS

FIG. 1a is a diagram of an application scenario according to an embodiment of this application;

FIG. 1b is a diagram of an application scenario according to an embodiment of this application;

FIG. 2a is a diagram of a scene audio signal encoding process;

FIG. 2b is a diagram of distribution of candidate virtual speakers;

FIG. 3 is a diagram of a scene audio signal decoding process;

FIG. 4 is a flowchart of a process 400 of a scene audio encoding method according to an embodiment of this application;

FIG. 5 is a flowchart of a process 500 of a scene audio decoding method according to an embodiment of this application; and

FIG. 6 is a diagram of a structure of a scene audio signal encoding apparatus 600 according to this application.

### DETAILED DESCRIPTION

To make the objectives, technical solutions, and advantages of this application clearer, the following clearly describes the technical solutions in this application with reference to the accompanying drawings in this application. Clearly, the described embodiments are merely some but not all of embodiments of this application. All other embodiments obtained by a person of ordinary skill in the art based on embodiments of this application without creative efforts shall fall within the protection scope of this application.

In embodiments of this specification, the claims, and the accompanying drawings of this application, the terms “first”, “second”, and the like are merely intended for differentiation in descriptions, but shall not be construed as indicating or implying relative importance or indicating or implying a sequence. In addition, the terms “include”, “have”, and any variant thereof are intended to cover non-exclusive inclusion, for example, include a series of operations or units. A method, system, product, or device is not necessarily limited to those expressly listed operations or units, but may include other operations or units that are not expressly listed or that are inherent to such a process, method, product, or device.

It should be understood that, in this application, “at least one” means one or more, and “a plurality of” means two or more. “And/or” describes an association relationship between associated objects, and indicates that three relationships may exist. For example, “A and/or B” may indicate the following three cases: Only A exists, only B exists, and both A and B exist, where A and B may be in a singular form or a plural form. The character “/” usually indicates an “or” relationship between the associated objects. “At least one of the following items (pieces)” or a similar expression thereof indicates any combination of the items, including one of the items (pieces) or any combination of a plurality of the items (pieces). For example, at least one of a, b, or c may indicate a, b, c, “a and b”, “a and c”, “b and c”, or “a, b, and c”, where a, b, and c may be in a singular form or a plural form.

The following first briefly describes related technologies in embodiments of this application.

Sound is a continuous wave generated by an object through vibration. An object that vibrates to produce a sound wave is referred to as a sound source. During propagation of the sound wave through a medium (for example, air, solid, or liquid), an auditory organ of a human or an animal can sense sound.

Features of the sound wave include a tone, intensity, and a timbre. The tone indicates a level of the sound. The intensity indicates a volume of the sound. The intensity may also be referred to as loudness or a volume. A unit of the intensity is decibel (dB). The timbre is also referred to as sound quality.

A frequency of the sound wave determines a level of the tone. A higher frequency indicates a higher tone. A quantity of times that the object vibrates within 1 second is referred to as a frequency, and a unit of the frequency is hertz (Hz). A frequency of sound that can be recognized by a human ear ranges from 20 Hz to 20000 Hz.

An amplitude of the sound wave determines the intensity. A larger amplitude indicates higher intensity. A shorter distance from the sound source indicates higher intensity.

A waveform of the sound wave determines the timbre. The waveform of the sound wave includes a square wave, a sawtooth wave, a sine wave, a pulse wave, and the like.

Sound may be classified into regular sound and irregular sound based on the features of the sound wave. The irregular sound is sound produced by a sound source through irregular vibration. The irregular sound is, for example, noise that affects people's work, study, rest, and the like. The regular sound is sound produced by a sound source through regular vibration. The regular sound includes voice and music. When the sound is represented electrically, the regular sound is an analog signal that changes continuously in time-frequency domain. The analog signal may be referred to as an audio signal. The audio signal is an information carrier that carries voice, music, and sound effect.

A human auditory sense has a capability of distinguishing location distribution of a sound source in space. Therefore, when hearing sound in space, a listener can sense a direction and a location of the sound in addition to a tone, intensity, and a timbre of the sound.

As people pay increasing attention to auditory system experience and have increasingly high requirements for quality, a three-dimensional audio technology emerges, to enhance a sense of depth, a sense of immersion, and a sense of space of sound. In this way, a listener not only feels sound produced by sound sources from the front, rear, left, and right, but also feels that space in which the listener is located is surrounded by a spatial sound field (“sound field” for short) produced by the sound sources, and feels that the sound spreads around. This creates “immersive” sound effect that enables the listener to feel like being in a cinema, a concert hall, or the like.

A scene audio signal in embodiments of this application may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal. The HOA signal is used below as an example for description.

It is well known that, when a sound wave is propagated in an ideal medium, a wave number is

$$k = \frac{w}{c} ,$$

and an angular frequency is w=2πf, where f is a frequency of the sound wave, and c is a sound velocity. Sound pressure p satisfies a formula (1), where V̅² is a Laplace operator.

$${∇}^{2} p + {k}^{2} p = 0 \qquad ( 1 )$$

It is assumed that a spatial system outside a human ear is a sphere, and a listener is at a center of the sphere. Sound transmitted from the outside of the sphere has a projection on a spherical surface, and sound outside the spherical surface is filtered out. It is assumed that a sound source is distributed on the spherical surface, and a sound field produced by the sound source on the spherical surface fits a sound field produced by an original sound source. That is, the three-dimensional audio technology is a sound field fitting method. In an embodiment, the equation in the formula (1) is solved in a spherical coordinate system. In a passive spherical area, a solution to the equation in the formula (1) is the following formula (2):

$$p ( r , θ , φ , k ) = s {\sum }_{m = 0}^{∞} ( 2 m + 1 ) {j}^{m} {j}_{m}^{k r} ( k r ) {\sum }_{0 \leq n \leq m , σ = \pm 1} {Y}_{m , n}^{σ} ( {θ}_{s} . {φ}_{s} ) {Y}_{m , n}^{σ} ( θ , φ ) \qquad ( 2 )$$

r indicates a radius of the sphere, θ indicates azimuth angle information (or referred to as azimuth information), p indicates pitch angle information (or referred to as pitch information), k indicates a wave number, s indicates an amplitude of an ideal plane wave, and m indicates a sequence number of an order of an HOA signal (or referred to as a number of an order of an HOA signal).

$${j}^{m} {j}_{m}^{k r} ( k r )$$

indicates a spherical Bessel function, and the spherical Bessel function is also referred to as a radial basis function, where the 1^{st} j indicates an imaginary unit, and

$$( 2 m + 1 ) {j}^{m} {j}_{m}^{k r} ( k r )$$

does not change with an angle.

$${Y}_{m , n}^{σ} ( θ , φ )$$

indicates a spherical harmonic function in θ and φ directions, and

$${Y}_{m , n}^{σ} ( {θ}_{s} , {φ}_{s} )$$

indicates a spherical harmonic function in a sound source direction. The HOA signal satisfies a formula (3).

$${B}_{m , n}^{σ} = s \cdot {Y}_{m , n}^{σ} ( {θ}_{s} , {φ}_{s} ) \qquad ( 3 )$$

The formula (3) is substituted into the formula (2), and the formula (2) may be transformed into a formula (4).

$$p ( r , θ , φ , k ) = {\sum }_{m = 0}^{∞} {j}^{m} {j}_{m}^{k r} ( k r ) {\sum }_{0 \leq n \leq m , σ = \pm 1} {B}_{m , n}^{σ} {Y}_{m , n}^{σ} ( θ , φ ) \qquad ( 4 )$$

m is truncated to an N^{th} term, that is, m=N, and

$${B}_{m , n}^{σ}$$

is used as an approximate description of the sound field. In this case,

$${B}_{m , n}^{σ}$$

may be referred to as an HOA coefficient (which may represent an N^{th}-order HOA signal). The sound field is an area in which a sound wave exists in a medium. N is an integer greater than or equal to 1.

The scene audio signal is an information carrier that carries spatial location information of a sound source in a sound field, and describes a sound field of a listener in space. The formula (4) indicates that the sound field may be expanded on a spherical surface based on a spherical harmonic function. In other words, the sound field may be decomposed into superposition of a plurality of plane waves. Therefore, the sound field described by the HOA signal may be expressed through superposition of a plurality of plane waves, and the sound field is reconstructed by using the HOA coefficient.

A to-be-encoded HOA signal may be an N^{th}-order HOA signal, and may be represented by an HOA coefficient or an ambisonics coefficient, where N is an integer greater than or equal to 1 (when N=1, a first-order HOA signal may be referred to as a first-order ambisonics (FOA) signal). The N^{th}-order HOA signal includes audio signals of (N+1)² channels.

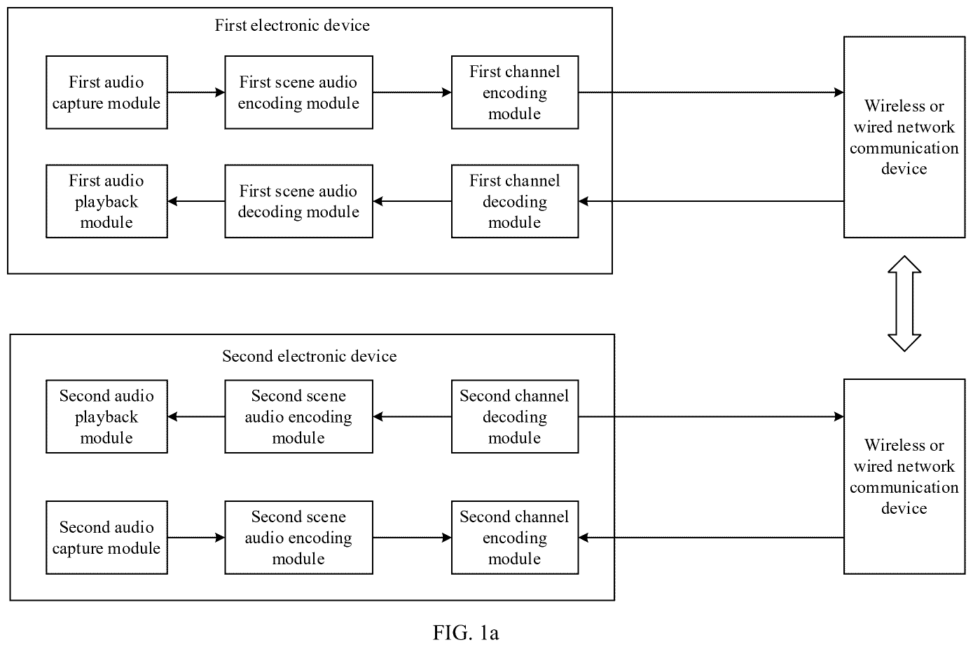

FIG. 1a is a diagram of an application scenario according to an embodiment of this application. As shown in FIG. 1a, the application scenario is a scene audio signal encoding and decoding scenario.

For example, a first electronic device may include a first audio capture module, a first scene audio encoding module, a first channel encoding module, a first channel decoding module, a first scene audio decoding module, and a first audio playback module. It should be understood that the first electronic device may include more or fewer modules than those shown in FIG. 1a. This is not limited in this embodiment of this application.

For example, a second electronic device may include a second audio capture module, a second scene audio encoding module, a second channel encoding module, a second channel decoding module, a second scene audio decoding module, and a second audio playback module. It should be understood that the second electronic device may include more or fewer modules than those shown in FIG. 1a. This is not limited in this embodiment of this application.

For example, a process in which the first electronic device encodes a scene audio signal and transmits an encoded signal to the second electronic device, and the second electronic device performs decoding and audio playback may include:

In the first electronic device, the first audio capture module may capture audio, and output a scene audio signal to the first scene audio encoding module. Then the first scene audio encoding module may encode the scene audio signal, and output a bitstream to the first channel encoding module. Then the first channel encoding module may perform channel encoding on the bitstream, and transmit, to the second electronic device through a wireless or wired network communication device, a bitstream obtained through channel encoding.

In the second electronic device, the second channel decoding module may perform channel decoding on received data to obtain a bitstream, and output the bitstream to the second scene audio decoding module. Then the second scene audio decoding module may decode the bitstream to obtain a reconstructed scene audio signal, and output the reconstructed scene audio signal to the second audio playback module, and the second audio playback module performs audio playback.

It should be noted that the second audio playback module may perform post-processing (for example, audio rendering (for example, converting a reconstructed scene audio signal including audio signals of (N+1)² channels into an audio signal in which a quantity of channels is the same as a quantity of speakers in the second electronic device), loudness normalization, user interaction, audio format conversion, or noise reduction) on the reconstructed scene audio signal, to convert the reconstructed scene audio signal into an audio signal suitable for playing by a speaker in the second electronic device.

It should be understood that a process in which the second electronic device encodes a scene audio signal and transmits an encoded signal to the first electronic device, and the first electronic device performs decoding and audio playback is similar to the foregoing process in which the first electronic device encodes a scene audio signal and transmits an encoded signal to the second electronic device, and the second electronic device performs decoding and audio playback. Details are not described herein again.

For example, the first electronic device and the second electronic device each may include but are not limited to a personal computer, a computer workstation, a smartphone, a tablet computer, a server, a smart camera, an intelligent vehicle, another type of cellular phone, a media consumption device, a wearable device, a set-top box, a game console, and the like.

For example, embodiments of this application may be applied to a virtual reality (VR)/augmented reality (AR) scenario. In an embodiment, the first electronic device is a server, and the second electronic device is a VR/AR device. In an embodiment, the second electronic device is a server, and the first electronic device is a VR/AR device.

For example, the first scene audio encoding module and the second scene audio encoding module may be scene audio encoders. The first scene audio decoding module and the second scene audio decoding module may be scene audio decoders.

For example, when the first electronic device encodes a scene audio signal and the second electronic device reconstructs a scene audio signal, the first electronic device may be referred to as an encoder, and the second electronic device may be referred to as a decoder. When the second electronic device encodes a scene audio signal and the first electronic device reconstructs a scene audio signal, the second electronic device may be referred to as an encoder, and the first electronic device may be referred to as a decoder.

FIG. 1b is a diagram of an application scenario according to an embodiment of this application. As shown in FIG. 1b, the application scenario is a scene audio signal transcoding scenario.

As shown in (1) in FIG. 1b, for example, a wireless or core network device may include a channel decoding module, another audio decoding module, a scene audio encoding module, and a channel encoding module. The wireless or core network device may be configured to perform audio transcoding.

For example, a specific application scenario may be as follows: A first electronic device is not provided with a scene audio encoding module, and is provided with only another audio encoding module. A second electronic device is provided with only a scene audio decoding module, and is not provided with another audio decoding module. The wireless or core network device may be used for transcoding, to enable the second electronic device to decode and play back a scene audio signal encoded by the first electronic device by using the other audio encoding module.

In an embodiment, the first electronic device encodes a scene audio signal by using the other audio encoding module to obtain a first bitstream, performs channel encoding on the first bitstream, and then sends a first bitstream obtained through channel encoding to the wireless or core network device. Then the channel decoding module of the wireless or core network device may perform channel decoding, and output, to the other audio decoding module, a first bitstream obtained through channel decoding. Then the other audio decoding module decodes the first bitstream to obtain a scene audio signal, and outputs the scene audio signal to the scene audio encoding module. Then the scene audio encoding module may encode the scene audio signal to obtain a second bitstream, and output the second bitstream to the channel encoding module. The channel encoding module performs channel encoding on the second bitstream, and then sends a second bitstream obtained through channel encoding to the second electronic device. In this way, the second electronic device may invoke the scene audio decoding module to decode a second bitstream obtained through channel decoding, to obtain a reconstructed scene audio signal; and subsequently, may perform audio playback on the reconstructed scene audio signal.

As shown in (2) in FIG. 1b, for example, a wireless or core network device may include a channel decoding module, a scene audio decoding module, another audio encoding module, and a channel encoding module. The wireless or core network device may be configured to perform audio transcoding.

For example, a specific application scenario may be as follows: A first electronic device is provided only with a scene audio encoding module, and is not provided with another audio encoding module. A second electronic device is not provided with a scene audio decoding module, and is provided only with another audio decoding module. The wireless or core network device may be used for transcoding, to enable the second electronic device to decode and play back a scene audio signal encoded by the first electronic device by using the scene audio encoding module.

In an embodiment, the first electronic device encodes a scene audio signal by using the scene audio encoding module to obtain a first bitstream, performs channel encoding on the first bitstream, and then sends a first bitstream obtained through channel encoding to the wireless or core network device. Then the channel decoding module of the wireless or core network device may perform channel decoding, and output, to the scene audio decoding module, a first bitstream obtained through channel decoding. Then the scene audio decoding module decodes the first bitstream to obtain a scene audio signal, and outputs the scene audio signal to the other audio encoding module. Then the other audio encoding module may encode the scene audio signal to obtain a second bitstream, and output the second bitstream to the channel encoding module. The channel encoding module performs channel encoding on the second bitstream, and then sends a second bitstream obtained through channel encoding to the second electronic device. In this way, the second electronic device may invoke the other audio decoding module to decode a second bitstream obtained through channel decoding, to obtain a reconstructed scene audio signal; and subsequently, may perform audio playback on the reconstructed scene audio signal.

For a scene audio signal encoding process and decoding process provided in the related art, refer to the following descriptions.

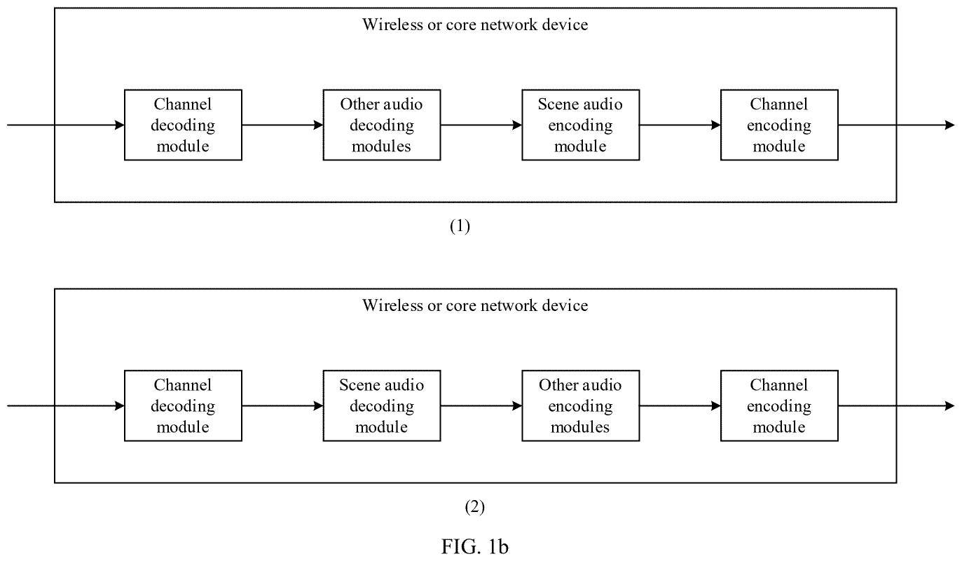

FIG. 2a is a diagram of a scene audio signal encoding process. As shown in FIG. 2a, the encoding process may include the following operations.

S201: Obtain a to-be-encoded scene audio signal, where the scene audio signal includes audio signals of C channels, and C is a positive integer.

For example, when the scene audio signal is an HOA signal, the HOA signal may be an (N1)^{th}-order HOA signal, to be specific,

$${B}_{m , n}^{σ}$$

in the foregoing formula (3) in a case in which m is truncated to an (N1)^{th} term.

For example, the (N1)^{th}-order HOA signal may include audio signals of C1 channels, where C1=(N1+1)². For example, when N1=3, the third-order HOA signal includes audio signals of 16 channels; or when N1=4, the fourth-order HOA signal includes audio signals of 25 channels.

S202: Determine attribute information of a target virtual speaker based on the scene audio signal.

S203: Encode a first audio signal in the scene audio signal and the attribute information of the target virtual speaker to obtain a first bitstream, where the first audio signal is audio signals of K channels in the scene audio signal, and K is a positive integer less than or equal to C1.

For example, a virtual speaker is a speaker that is virtual, and is not a speaker that actually exists.

For example, the scene audio signal may be expressed through superposition of a plurality of plane waves, and then a target virtual speaker used to simulate a sound source in the scene audio signal may be determined. In this way, during subsequent decoding, a virtual speaker signal corresponding to the target virtual speaker is used to reconstruct the scene audio signal.

In an embodiment, a plurality of candidate virtual speakers at different locations may be set on a spherical surface, and then a target virtual speaker whose location matches a location of the sound source in the scene audio signal may be selected from the plurality of candidate virtual speakers.

FIG. 2b is a diagram of distribution of candidate virtual speakers. As shown in FIG. 2b, a plurality of candidate virtual speakers may be evenly distributed on a spherical surface, and one point on the spherical surface represents one candidate virtual speaker.

It should be noted that a quantity and distribution of candidate virtual speakers are not limited, and may be set according to a requirement.

For example, a target virtual speaker whose location corresponds to the location of the sound source in the scene audio signal may be selected from the plurality of candidate virtual speakers based on the scene audio signal. There may be one or more target virtual speakers.

In an embodiment, the target virtual speaker may be preset.

For example, in an embodiment, during decoding, the scene audio signal may be reconstructed based on the virtual speaker signal. However, a bit rate increases if the virtual speaker signal of the target virtual speaker is directly transmitted. The virtual speaker signal of the target virtual speaker may be generated based on the attribute information of the target virtual speaker and scene audio signals of some or all of the channels. Therefore, the attribute information of the target virtual speaker may be obtained, and the audio signals of the K channels in the scene audio signal is obtained as the first audio signal. Then the first audio signal and the attribute information of the target virtual speaker are encoded to obtain the first bitstream.

For example, operations such as downmixing, transformation, quantization, and entropy encoding may be performed on the first audio signal and the attribute information of the target virtual speaker to obtain the first bitstream. In other words, the first bitstream may include encoded data of the first audio signal in the scene audio signal and encoded data of the attribute information of the target virtual speaker.

In addition, an encoder directly encodes audio signals of some of the channels in the scene audio signal, without calculating a virtual speaker signal or a residual signal, so that encoding complexity of the encoder is lower.

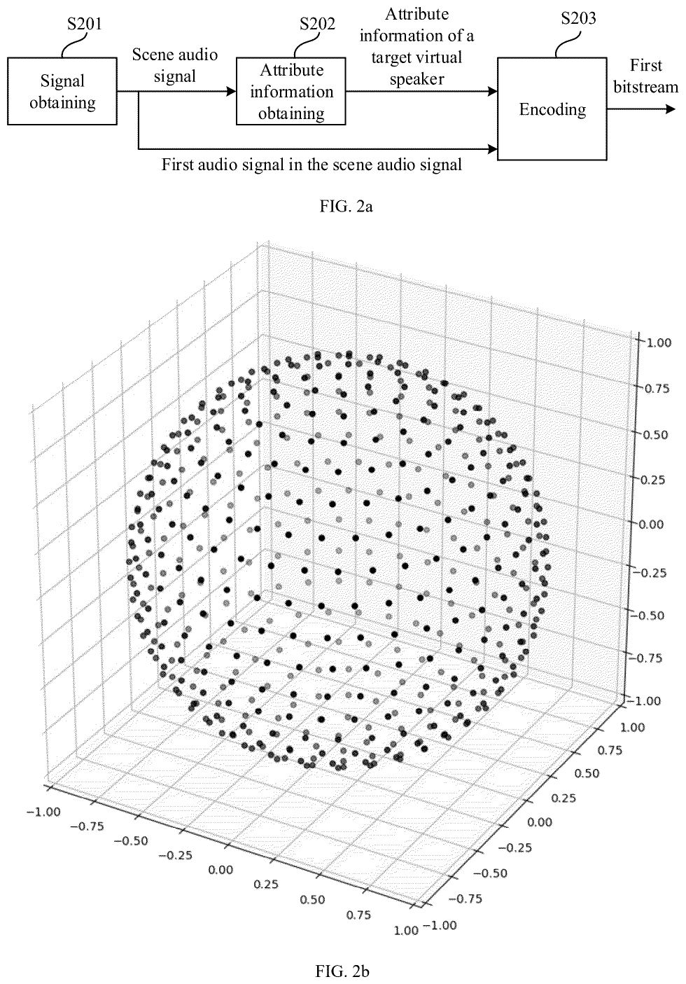

FIG. 3 is a diagram of a scene audio signal decoding process. FIG. 3 shows a decoding process corresponding to the encoding process in FIG. 2. As shown in FIG. 3, the decoding process may include the following operations.

S301: Receive a first bitstream.

S302: Decode the first bitstream to obtain a first reconstructed signal and attribute information of a target virtual speaker.

For example, encoded data, included in the first bitstream, of a first audio signal in a scene audio signal may be decoded to obtain the first reconstructed signal. That is, the first reconstructed signal is a reconstructed signal of the first audio signal. In addition, encoded data, included in the first bitstream, of the attribute information of the target virtual speaker may be decoded to obtain the attribute information of the target virtual speaker.

It should be understood that, when an encoder performs lossy compression on the first audio signal in the scene audio signal, the first reconstructed signal obtained by a decoder through decoding is different from the first audio signal encoded by the encoder; or when an encoder performs lossless compression on the first audio signal, the first reconstructed signal obtained by a decoder through decoding is the same as the first audio signal encoded by the encoder.

It should be understood that, when the encoder performs lossy compression on the attribute information of the target virtual speaker, the attribute information obtained by the decoder through decoding is different from the attribute information encoded by the encoder; or when the encoder performs lossless compression on the attribute information of the virtual speaker, the attribute information obtained by the decoder through decoding is the same as the attribute information encoded by the encoder.

S303: Generate, based on the attribute information and the first reconstructed signal, a virtual speaker signal corresponding to the target virtual speaker.

S304: Perform reconstruction based on the attribute information and the virtual speaker signal to obtain a first reconstructed scene audio signal.

For example, it can be learned from the foregoing descriptions that the scene audio signal may be reconstructed based on the virtual speaker signal, and then the virtual speaker signal corresponding to the target virtual speaker may be generated based on the attribute information of the target virtual speaker and the first reconstructed signal. One target virtual speaker corresponds to one virtual speaker signal, and the virtual speaker signal is a plane wave. Then reconstruction is performed based on the attribute information of the target virtual speaker and the virtual speaker signal to generate the first reconstructed scene audio signal.

For example, when the scene audio signal is an HOA signal, the first reconstructed scene audio signal obtained through reconstruction may also be an HOA signal. The HOA signal may be an (N2)^{th}-order HOA signal, where N2 is a positive integer. For example, the (N2)^{th}-order HOA signal may include audio signals of C2 channels, where C2=(N2+1)².

For example, the order N2 of the first reconstructed scene audio signal may be greater than or equal to the order N1 of the scene audio signal in the embodiment shown in FIG. 2a. Correspondingly, the quantity C2 of channels of the audio signal included in the first reconstructed scene audio signal may be greater than or equal to the quantity C1 of channels of the audio signal included in the scene audio signal in the embodiment shown in FIG. 2a.

In the scene audio signal encoding process and decoding process described in FIG. 2a to FIG. 3, encoding and decoding efficiency can be improved. However, processing of a transient signal is not considered. This may lead to degradation of quality of a reconstructed audio signal and therefore affect auditory experience of a user.

To resolve the foregoing technical problem, in the application scenarios shown in FIG. 1a and FIG. 1b, embodiments of this application provide a scene audio encoding method and apparatus. The technical solutions are described in the following embodiments.

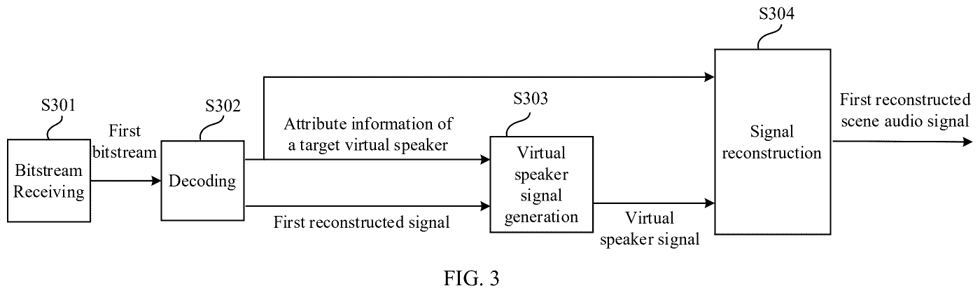

FIG. 4 is a flowchart of a process 400 of a scene audio encoding method according to an embodiment of this application. As shown in FIG. 4, the process 400 may be performed by an encoder, for example, the foregoing first electronic device or second electronic device. The process 400 is described as a series of operations. It should be understood that the process 400 may be performed in various sequences and/or simultaneously, and is not limited to an execution sequence shown in FIG. 4. The process 400 includes the following operations.

Operation 401: Obtain a to-be-encoded scene audio signal.

The scene audio signal is an information carrier that carries spatial location information of a sound source in a sound field, and describes a sound field of a listener in space. The scene audio signal may include audio signals of C channels, where C is a positive integer.

In an embodiment, the scene audio signal may be an HOA signal, and the HOA signal may be an N^{th}-order HOA signal including audio signals of (N+1)² channels. In this case, C=(N+1)².

Operation 402: Perform transient detection on M channels, among the C channels, that need transient detection, to obtain transient identifiers of the M channels.

Transient is also referred to as a transitory state. Energy of an audio signal of one or more channels among a plurality of channels of the scene audio signal may suddenly change. For example, if energy suddenly increases at a specific moment, a channel with the sudden change may be considered as a channel with transient (or a transitory state). A process of determining whether a channel includes a transient signal may be referred to as transient detection.

The M channels that need transient detection are M channels, among the C channels of the scene audio signal, on which transient detection needs to be performed. M is a positive integer greater than or equal to 1 and less than or equal to C. To be specific, M being the minimum value 1 indicates that only one of the C channels of the scene audio signal needs transient detection, M being the maximum value C indicates that all of the C channels of the scene audio signal need transient detection, and M being any value between 1 and C indicates that some of the C channels of the scene audio signal need transient detection.

In an embodiment, the encoder may determine, in a preset manner, the M channels that need transient detection.

For example, a transient detection table is pre-generated, where 1 is written into a corresponding table for a channel among the C channels that needs transient detection, and 0 is written into a corresponding table for a channel that does not need transient detection. The encoder may obtain the M channels by querying the transient detection table.

For example, if the transient detection table is generated based on a horizontal plane and directivity of HOA channels, 1 is written for W, Y, X, V, U, Q and P channels, and 0 is written for other channels.

For example, M channels may be specified based on a user configuration; or it may be specified that a quantity of channels included in a Kth order is M channels, where K is less than N.

After determining the M channels that need transient detection, the encoder may perform transient detection on the M channels one by one to obtain respective transient detection results of the M channels, and then assign transient identifiers to corresponding channels based on the transient detection results.

In an embodiment, the transient identifier may be represented by a 1-bit syntax element. For example, 1 indicates that a transient signal exists, and θ indicates that no transient signal exists. If a transient detection result of a channel is that the channel includes a transient signal, a transient identifier of the channel is set to 1. If a transient detection result of a channel is that the channel includes no transient signal, a transient identifier of the channel is set to 0.

In an embodiment, if M=1, the encoder may perform transient detection on one of the C channels in the scene audio signal. For the one of the C channels, a fixed channel may be selected. For example, one channel that needs transient detection is the W channel (to be specific, a channel 1 (also referred to as the 1^{st} channel) among the foregoing (N+1)² channels). The encoder may calculate an energy envelope of the W channel; compare a ratio of an envelope peak value to an envelope trough value with a first threshold; and if the ratio is greater than the first threshold, determine that the W channel includes a transient signal; or otherwise, determine that the W channel includes no transient signal.

The first threshold may be preset, for example, 0.1. A value of the first threshold is not limited in this embodiment of this application.

The high-frequency signal and the low-frequency signal may be distinguished through comparison with a preset second threshold. For example, it is determined that a signal on a frequency band greater than T kHz (the second threshold) in the W channel is a high-frequency signal, and it is determined that a signal on a frequency band less than or equal to T kHz in the W channel is a low-frequency signal. Energy of a signal may be calculated by using a method of a square of an amplitude. For example, the second threshold may be 4 kHz. This is not limited in this embodiment of this application.

After obtaining a transient detection result of the W channel, the encoder obtains a transient identifier of the W channel. In an embodiment, the transient identifier of the W channel may be used as transient identifiers of C channels of a current frame in the scene audio signal. To be specific, if the W channel includes a transient signal, all of the C channels include transient signals; or if the W channel includes no transient signal, none of the C channels includes a transient signal.

In an embodiment, if M=C, the encoder may perform transient detection on all of the C channels in the scene audio signal to obtain a transient identifier of each channel. For a transient detection method for any channel, refer to the foregoing transient detection method for the W channel. Details are not described herein again.

In an embodiment, if 1<M≤C, the encoder may perform transient detection on some of the C channels in the scene audio signal to obtain transient identifiers of the channels. A channel that does not undergo transient detection is considered as including no transient signal. For a transient detection method for any channel, refer to the foregoing transient detection method for the W channel. Details are not described herein again.

Operation 403: Encode the transient identifiers of the M channels and the scene audio signals to obtain a bitstream.

In this embodiment of this application, the encoder encodes the scene audio signal by using at least two encoding methods, where the at least two encoding methods include direct encoding. The direct encoding may be an encoding scheme for encoding a signal.

In an embodiment, the C channels in the scene audio signal may be divided into at least two types of channels, where direct encoding is performed on a first channel, and other encoding is performed on a second channel.

The other encoding may include spatial encoding and decorrelation. For the spatial encoding, refer to an embodiment shown in FIG. 2a. Spatial encoding information (also referred to as attribute information of a target virtual speaker) is extracted based on the to-be-encoded scene audio signal, and the spatial encoding information is encoded into a bitstream. The decorrelation may be time-domain decorrelation or frequency-domain decorrelation, and a delay and a phase of a decorrelation signal is adjusted by using an all-pass filter.

The encoder may encode the scene audio signal by using the foregoing method, including: performing direct encoding on the first channel, and performing spatial encoding on the second channel; or performing direct encoding on the first channel, and performing decorrelation on a third channel; or performing direct encoding on the first channel, performing spatial encoding on the second channel, and performing decorrelation on a third channel.

For example, N=3, C=16, the scene audio signal includes audio signals of 16 channels, and the 16 channels are numbered from 1 to 16.

TABLE 1

| Channel | | | | |
|---|---|---|---|---|
| number | 256 kbps | 384 kbps | 512 kbps | 768 kbps |
| 1 | Direct encoding | Direct encoding | Direct encoding | Direct encoding |
| | and decoding | and decoding | and decoding | and decoding |
| 2 | Direct encoding | Direct encoding | Direct encoding | Direct encoding |
| | and decoding | and decoding | and decoding | and decoding |
| 3 | Direct encoding | Direct encoding | Direct encoding | Direct encoding |
| | and decoding | and decoding | and decoding | and decoding |
| 4 | Direct encoding | Direct encoding | Direct encoding | Direct encoding |
| | and decoding | and decoding | and decoding | and decoding |
| 5 | Decorrelation | Decorrelation | Direct encoding | Direct encoding |
| | | | and decoding | and decoding |
| 6 | Spatial encoding | Spatial encoding | Direct encoding | Direct encoding |
| | and decoding | and decoding | and decoding | and decoding |
| 7 | Spatial encoding | Spatial encoding | Spatial encoding | Direct encoding |
| | and decoding | and decoding | and decoding | and decoding |
| 8 | Spatial encoding | Spatial encoding | Spatial encoding | Direct encoding |
| | and decoding | and decoding | and decoding | and decoding |
| 9 | Decorrelation | Decorrelation | Spatial encoding | Direct encoding |
| | | | and decoding | and decoding |
| 10 | Decorrelation | Decorrelation | Decorrelation | Decorrelation |
| 11 | Spatial encoding | Spatial encoding | Spatial encoding | Spatial encoding |
| | and decoding | and decoding | and decoding | and decoding |
| 12 | Spatial encoding | Spatial encoding | Spatial encoding | Spatial encoding |
| | and decoding | and decoding | and decoding | and decoding |
| 13 | Spatial encoding | Spatial encoding | Spatial encoding | Spatial encoding |
| | and decoding | and decoding | and decoding | and decoding |
| 14 | Spatial encoding | Spatial encoding | Spatial encoding | Spatial encoding |
| | and decoding | and decoding | and decoding | and decoding |
| 15 | Spatial encoding | Spatial encoding | Spatial encoding | Spatial encoding |
| | and decoding | and decoding | and decoding | and decoding |
| 16 | Decorrelation | Decorrelation | Decorrelation | Decorrelation |

TABLE 2

| Channel | | | | |
|---|---|---|---|---|
| number | 256 kbps | 384 kbps | 512 kbps | 768 kbps |
| 1 | Direct encoding | Direct encoding | Direct encoding | Direct encoding |
| | and decoding | and decoding | and decoding | and decoding |
| 2 | Direct encoding | Direct encoding | Direct encoding | Direct encoding |
| | and decoding | and decoding | and decoding | and decoding |
| 3 | Direct encoding | Direct encoding | Direct encoding | Direct encoding |
| | and decoding | and decoding | and decoding | and decoding |
| 4 | Direct encoding | Direct encoding | Direct encoding | Direct encoding |
| | and decoding | and decoding | and decoding | and decoding |
| 5 | Decorrelation | Decorrelation | Direct encoding | Direct encoding |
| | | | and decoding | and decoding |
| 6 | Spatial encoding | Spatial encoding | Direct encoding | Direct encoding |
| | and decoding | and decoding | and decoding | and decoding |
| 7 | Spatial encoding | Spatial encoding | Spatial encoding | Spatial encoding |
| | and decoding | and decoding | and decoding | and decoding/ |
| | | | | Decorrelation |
| 8 | Spatial encoding | Spatial encoding | Spatial encoding | Direct encoding |
| | and decoding | and decoding | and decoding | and decoding |
| 9 | Decorrelation | Decorrelation | Spatial encoding | Direct encoding |
| | | | and decoding | and decoding |
| 10 | Decorrelation | Decorrelation | Decorrelation | Decorrelation |
| 11 | Spatial encoding | Spatial encoding | Spatial encoding | Spatial encoding |
| | and decoding | and decoding | and decoding | and decoding |
| 12 | Spatial encoding | Spatial encoding | Spatial encoding | Spatial encoding |
| | and decoding | and decoding | and decoding | and decoding |
| 13 | Spatial encoding | Spatial encoding | Spatial encoding | Spatial encoding |
| | and decoding | and decoding | and decoding | and decoding |
| 14 | Spatial encoding | Spatial encoding | Spatial encoding | Spatial encoding |
| | and decoding | and decoding | and decoding | and decoding |
| 15 | Spatial encoding | Spatial encoding | Spatial encoding | Spatial encoding |
| | and decoding | and decoding | and decoding | and decoding |
| 16 | Decorrelation | Decorrelation | Decorrelation | Decorrelation |

Table 1 and Table 2 each show a configuration example of an encoding and decoding method for a third-order HOA signal at different rates. Table 1 is used as an example.

When a rate is 256 kbps, first channels on which direct encoding is performed includes channels 1 to 4, second channels on which spatial encoding is performed include channels 6 to 8, and 11 to 15, and third channels on which decorrelation is performed include channels 5, 9, 10, and 16.

When a rate is 384 kbps, first channels on which direct encoding is performed include channels 1 to 4, second channel on which spatial encoding is performed include channels 6 to 8, and 11 to 15, and third channels on which decorrelation is performed include channels 5, 9, 10, and 16.

When a rate is 512 kbps, first channels on which direct encoding is performed include channels 1 to 6, second channels on which spatial encoding is performed include channels 7 to 9, and 11 to 15, and third channels on which decorrelation is performed include channels 10 and 16.

When a rate is 768 kbps, first channels on which direct encoding is performed includes channels 1 to 9, second channels on which spatial encoding is performed include channels 11 to 15, and third channels on which decorrelation is performed include channels 10 and 16.

In addition, the encoder further writes the transient identifiers of the M channels into the bitstream, for a decoder to perform transient recovery.

In this embodiment of this application, the encoder performs transient detection on the selected M channels, and writes a transient detection result (a transient detection identifier) into the bitstream, for the decoder to perform transient recovery. In this way, a transient signal in the scene audio signal can be processed, to improve quality of a reconstructed audio signal and auditory experience of a user.

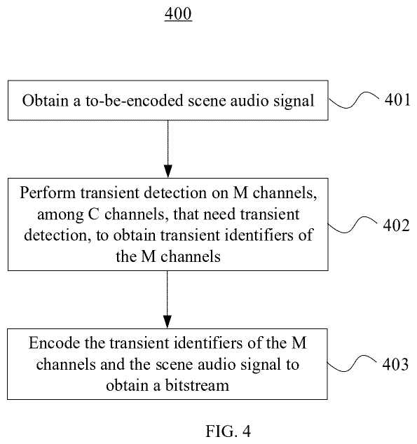

FIG. 5 is a flowchart of a process 500 of a scene audio decoding method according to an embodiment of this application. As shown in FIG. 5, the process 500 may be performed by a decoder, for example, the foregoing second electronic device or first electronic device. The process 500 is described as a series of operations. It should be understood that the process 500 may be performed in various sequences and/or simultaneously, and is not limited to an execution sequence shown in FIG. 5. The process 500 includes the following operations.

Operation 501: Receive a bitstream.

Operation 502: Decode the bitstream by using at least two decoding methods to obtain a reconstructed scene audio signal.

Corresponding to an encoder, the decoder may decode the bitstream, especially a part that is in the bitstream and that corresponds to data of a scene audio signal, by using the at least two decoding methods. The at least two decoding methods include direct decoding, and may further include spatial decoding and/or decorrelation. The direct decoding may be a decoding scheme for decoding encoded data that is obtained by encoding a signal.

That the decoder decodes the bitstream includes: performing direct decoding on a first bitstream to obtain a reconstructed signal of a first channel, and performing spatial decoding on a second bitstream to obtain a reconstructed signal of a second channel; or performing direct decoding on a first bitstream to obtain a reconstructed signal of a first channel, and performing decorrelation on a third bitstream to obtain a reconstructed signal of a third channel; or performing direct decoding on a first bitstream to obtain a reconstructed signal of a first channel, performing spatial decoding on a second bitstream to obtain a reconstructed signal of a second channel, and performing decorrelation on a third bitstream to obtain a reconstructed signal of a third channel.

The reconstructed scene audio signal may include the reconstructed signal of the first channel, and include the reconstructed signal of the second channel and/or the reconstructed signal of the third channel. The reconstructed scene audio signal includes reconstructed audio signals of C channels, where C is a positive integer.

For a decoding method used by the decoder, refer to the example shown in Table 1. Details are not described herein again.

Operation 503: Perform transient detection on M channels, among the C channels, that need transient detection, to obtain transient identifiers of the M channels.

Transient is also referred to as a transitory state. Energy of a reconstructed audio signal of one or more channels among a plurality of channels of the reconstructed scene audio signal may suddenly change. For example, if energy suddenly increases at a specific moment, a channel with the sudden change may be considered as a channel with transient (or a transitory state). A process of determining whether a channel includes a transient signal may be referred to as transient detection.

The M channels that need transient detection are M channels, among the C channels of the reconstructed scene audio signal, on which transient detection needs to be performed. M is a positive integer greater than or equal to 1 and less than or equal to C. To be specific, M being the minimum value 1 indicates that only one of the C channels of the reconstructed scene audio signal needs transient detection, M being the maximum value C indicates that all of the C channels of the reconstructed scene audio signal need transient detection, and M being any value between 1 and C indicates that some of the C channels of the reconstructed scene audio signal need transient detection.

In an embodiment, the decoder may determine, in a preset manner, the M channels that need transient detection.

For example, a transient detection table is pre-generated, where 1 is written into a corresponding table for a channel among the C channels that needs transient detection, and 0 is written into a corresponding table for a channel that does not need transient detection. The decoder may obtain the M channels by querying the transient detection table.

For example, if the transient detection table is generated based on a horizontal plane and directivity of HOA channels, 1 is written for W, Y, X, V, U, Q and P channels, and 0 is written for other channels.

For example, M channels may be specified based on a user configuration; or it may be specified that a quantity of channels included in a Kth order is M channels, where K is less than N.

After determining the M channels that need transient detection, the decoder may perform transient detection on the M channels one by one to obtain respective transient detection results of the M channels, and then assign transient identifiers to corresponding channels based on the transient detection results.

In an embodiment, the transient identifier may be represented by a 1-bit syntax element. For example, 1 indicates that a transient signal exists, and θ indicates that no transient signal exists. If a transient detection result of a channel is that the channel includes a transient signal, a transient identifier of the channel is set to 1. If a transient detection result of a channel is that the channel includes no transient signal, a transient identifier of the channel is set to 0.

In an embodiment, if M=1, the decoder may perform transient detection on one of the C channels in the scene audio signal. For the one of the C channels, a fixed channel may be selected. For example, one channel that needs transient detection is the W channel (to be specific, a channel 1 (also referred to as the 1^{st} channel) among the foregoing (N+1)² channels). The decoder may calculate an energy envelope of the W channel; compare a ratio of an envelope peak value to an envelope trough value with a first threshold; and if the ratio is greater than the first threshold, determine that the W channel includes a transient signal; or otherwise, determine that the W channel includes no transient signal.

The first threshold may be preset, for example, 0.1. A value of the first threshold is not limited in this embodiment of this application.

The high-frequency signal and the low-frequency signal may be distinguished through comparison with a preset second threshold. For example, it is determined that a signal on a frequency band greater than T kHz (the second threshold) in the W channel is a high-frequency signal, and it is determined that a signal on a frequency band less than or equal to T kHz in the W channel is a low-frequency signal. Energy of a signal may be calculated by using a method of a square of an amplitude. For example, the second threshold may be 4 kHz. This is not limited in this embodiment of this application.

After obtaining a transient detection result of the W channel, the decoder obtains a transient identifier of the W channel. In an embodiment, the transient identifier of the W channel may be used as transient identifiers of C channels of a current frame in the scene audio signal. To be specific, if the W channel includes a transient signal, all of the C channels include transient signals; or if the W channel includes no transient signal, none of the C channels includes a transient signal.

In an embodiment, if M=C, the decoder may perform transient detection on all of the C channels in the scene audio signal to obtain a transient identifier of each channel. For a transient detection method for any channel, refer to the foregoing transient detection method for the W channel. Details are not described herein again.

In an embodiment, if 1<M≤C, the decoder may perform transient detection on some of the C channels in the scene audio signal to obtain transient identifiers of the channels. A channel that does not undergo transient detection is considered as including no transient signal. For a transient detection method for any channel, refer to the foregoing transient detection method for the W channel. Details are not described herein again.

Operation 504: Perform, based on the transient identifiers of the M channels, transient recovery on a channel with a transient signal among the M channels.

The decoder may determine, from the M channels based on the transient identifiers of the M channels, a channel including a transient signal, and then perform transient recovery on the channel.

In this embodiment of this application, the decoder performs transient detection on the selected M channels, so that the decoder can perform transient recovery. In this way, a transient signal in the scene audio signal can be processed. This can reduce a bitstream size because no transient identifier needs to be written into a bitstream, and can also improve quality of a reconstructed audio signal and auditory experience of a user.

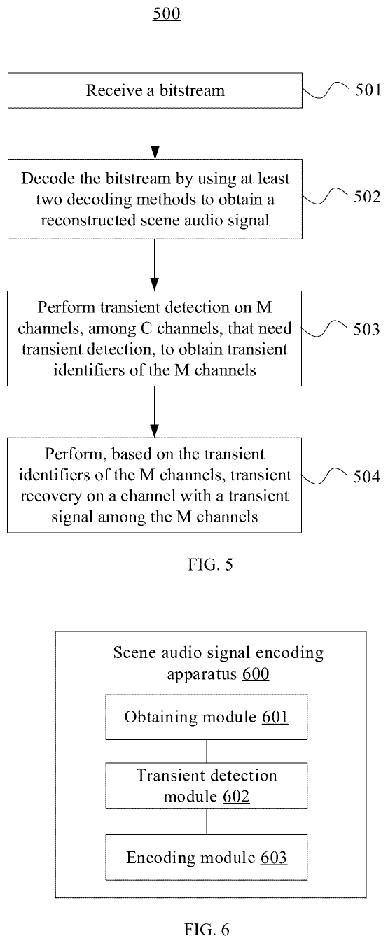

FIG. 6 is a diagram of a structure of a scene audio signal encoding apparatus 600 according to this application. As shown in FIG. 6, the scene audio signal encoding apparatus 600 in this embodiment may be used in an encoder. The scene audio signal encoding apparatus 600 may include an obtaining module 601, a transient detection module 602, and an encoding module 603.

The obtaining module 601 is configured to obtain a to-be-encoded scene audio signal, where the scene audio signal includes audio signals of C channels, and C is a positive integer. The transient detection module 602 is configured to perform transient detection on M channels, among the C channels, that need transient detection, to obtain transient identifiers of the M channels, where the transient identifier indicates whether a corresponding channel includes a transient signal, and 1≤M≤C. The encoding module 603 is configured to encode the transient identifiers of the M channels and the scene audio signal to obtain a bitstream.

In an embodiment, when M=1, the M channels are a W channel among the C channels; or when 1<M<C, the M channels are preset.

In an embodiment, the transient detection module 602 is configured to: obtain an energy difference between a high-frequency signal and a low-frequency signal of a target channel, where the high-frequency signal is a signal with a frequency greater than a first threshold among audio signals of the target channel, the low-frequency signal is a signal with a frequency less than or equal to the first threshold among the audio signals of the target channel, and the target channel is any one of the M channels; and when the energy difference is greater than a second threshold, assign a first transient identifier to the target channel, where the first transient identifier indicates that the target channel includes a transient signal; or when the energy difference is less than or equal to a second threshold, assign a second transient identifier to the target channel, where the second transient identifier indicates that the target channel includes no transient signal.

In an embodiment, the scene audio signal is encoded by using at least two encoding methods, and the at least two encoding methods include direct encoding, and further include spatial encoding and/or decorrelation.

In an embodiment, the encoding module 603 is configured to: perform direct encoding on a first channel, and perform spatial encoding on a second channel; or perform direct encoding on a first channel, and perform decorrelation on a third channel; or perform direct encoding on a first channel, perform spatial encoding on a second channel, and perform decorrelation on a third channel, where the first channel, the second channel, or the third channel is a type of channel among the C channels.

The apparatus in this embodiment may be configured to perform the technical solution in the method embodiment shown in FIG. 4. Embodiments and technical effects thereof are similar. Details are not described herein again.

In an embodiment, the operations in the foregoing method embodiments may be performed by using a hardware integrated logic circuit in a processor or instructions in a form of software. The processor may be a general-purpose processor, a digital signal processor (DSP), an application-specific integrated circuit (ASIC), a field programmable gate array (FPGA) or another programmable logic device, a discrete gate or transistor logic device, or a discrete hardware component. The general-purpose processor may be a microprocessor, or the processor may be any conventional processor or the like. The operations of the methods disclosed in embodiments of this application may be directly performed by a hardware encoding processor, or performed by hardware in an encoding processor in combination with a software module. The software module may be located in a mature storage medium in the art, for example, a random access memory, a flash memory, a read-only memory, a programmable read-only memory, an electrically erasable programmable memory, or a register. The storage medium is located in a memory, and the processor reads information in the memory and performs the operations of the foregoing methods based on hardware of the processor.

The memory in the foregoing embodiments may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and serves as an external cache. By way of example but not limitative description, RAMs in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (synchlink DRAM, SLDRAM), and a direct rambus random access memory (DR RAM). It should be noted that the memory in the systems and the methods described in this specification is intended to include but is not limited to these memories and any other appropriate type of memory.

A person of ordinary skill in the art may be aware that units and algorithm operations in examples described with reference to embodiments disclosed in this specification can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application. However, it should not be considered that the embodiment goes beyond the scope of this application.

It can be clearly understood by a person skilled in the art that, for ease and brevity of description, for detailed working processes of the foregoing systems, apparatuses, and units, reference may be made to corresponding processes in the foregoing method embodiments. Details are not described herein again.

In the several embodiments provided in this application, it should be understood that the disclosed systems, apparatuses, and methods may be implemented in other manners. For example, the described apparatus embodiments are merely examples. For example, division into the units is merely logical function division. In an embodiment, another division manner may be used. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the apparatuses or units may be implemented in electrical, mechanical, or other forms.

The units described as separate components may or may not be physically separated, and components shown as units may or may not be physical units, to be specific, may be located in one place, or may be distributed on a plurality of network units. Some or all of the units may be selected according to actual requirements to achieve the objectives of the solutions of embodiments.

In addition, functional units in embodiments of this application may be integrated into one processing unit, or each unit may exist alone physically, or two or more units may be integrated into one unit.

When the functions are implemented in a form of a software functional unit and sold or used as an independent product, the functions may be stored in a computer-readable storage medium. Based on such an understanding, the technical solutions in this application essentially, or the part contributing to the conventional technology, or some of the technical solutions may be implemented in a form of a software product. The computer software product is stored in a storage medium, and includes several instructions for instructing a computer device (a personal computer, a server, a network device, or the like) to perform all or some of the operations of the methods in embodiments of this application. The storage medium includes any medium that can store program code, for example, a USB flash drive, a removable hard disk drive, a read-only memory (read-only memory, ROM), a random access memory (random access memory, RAM), a magnetic disk, or a compact disc.

The foregoing descriptions are merely embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A computer-implemented method of scene audio signal encoding, the method comprising:
obtaining a to-be-encoded scene audio signal comprising audio signals of C channels, wherein C is a positive integer;
performing transient detection on M channels, among the C channels, that need transient detection, to obtain transient identifiers of the M channels, wherein each transient identifier indicates whether a corresponding channel comprises a transient signal, and 1≤M≤C; and
encoding the transient identifiers of the M channels and the to-be-encoded scene audio signal to obtain a bitstream.

2. The method according to claim 1, wherein when M=1, the M channels are a W channel among the C channels; or
when 1<M<C, the M channels are preset.

3. The method according to claim 1, wherein performing the transient detection on the M channels, among the C channels, that need transient detection comprises:
obtaining an energy difference between a high-frequency signal and a low-frequency signal of a target channel, wherein the high-frequency signal is a signal with a frequency greater than a first threshold among audio signals of the target channel, the low-frequency signal is a signal with a frequency less than or equal to the first threshold among the audio signals of the target channel, and the target channel is one of the M channels; and
when the energy difference is greater than a second threshold, assigning a first transient identifier to the target channel, wherein the first transient identifier indicates that the target channel comprises a transient signal; or
when the energy difference is less than or equal to a second threshold, assigning a second transient identifier to the target channel, wherein the second transient identifier indicates that the target channel comprises no transient signal.

4. The method according to claim 1, wherein the to-be-encoded scene audio signal is encoded using at least two encoding methods, and the at least two encoding methods comprise direct encoding, and further comprise at least one of spatial encoding or decorrelation.

5. The method according to claim 4, wherein encoding the to-be-encoded scene audio signal using the at least two encoding methods comprises:
performing direct encoding on a first channel, and performing spatial encoding on a second channel; or
performing direct encoding on the first channel, and performing decorrelation on a third channel; or
performing direct encoding on the first channel, performing spatial encoding on the second channel, and performing decorrelation on the third channel;
wherein the first channel, the second channel, or the third channel is a type of channel among the C channels.

6. An electronic device, comprising:
one or more processors; and
a memory storing one or more programs, which when executed by the one or more processors, cause the electronic device to:
obtain a to-be-encoded scene audio signal comprising audio signals of C channels, wherein C is a positive integer;
perform transient detection on M channels, among the C channels, that need transient detection, to obtain transient identifiers of the M channels, wherein each transient identifier indicates whether a corresponding channel comprises a transient signal, and 1<M≤C; and
encode the transient identifiers of the M channels and the to-be-encoded scene audio signal to obtain a bitstream.

7. The electronic device according to claim 6, wherein when M=1, the M channels are a W channel among the C channels; or
when 1<M<C, the M channels are preset.

8. The electronic device according to claim 6, wherein the electronic device is caused to perform the transient detection on M channels, among the C channels, that need transient detection comprises the electronic device is caused to:
obtain an energy difference between a high-frequency signal and a low-frequency signal of a target channel, wherein the high-frequency signal is a signal with a frequency greater than a first threshold among audio signals of the target channel, the low-frequency signal is a signal with a frequency less than or equal to the first threshold among the audio signals of the target channel, and the target channel is one of the M channels; and
when the energy difference is greater than a second threshold, assign a first transient identifier to the target channel, wherein the first transient identifier indicates that the target channel comprises a transient signal; or
when the energy difference is less than or equal to a second threshold, assign a second transient identifier to the target channel, wherein the second transient identifier indicates that the target channel comprises no transient signal.

9. The electronic device according to claim 6, wherein the to-be-encoded scene audio signal is encoded by use of at least two encoding methods, and the at least two encoding methods comprise direct encoding, and further comprise at least one of spatial encoding or decorrelation.

10. The electronic device according to claim 9, wherein the electronic device is caused to encode the to-be-encoded scene audio signal by use of the at least two encoding methods comprises the electronic device is caused to:
perform direct encoding on a first channel, and performing spatial encoding on a second channel; or
perform direct encoding on the first channel, and performing decorrelation on a third channel; or
perform direct encoding on the first channel, performing spatial encoding on the second channel, and performing decorrelation on the third channel;
wherein the first channel, the second channel, or the third channel is a type of channel among the C channels.

11. A non-transitory computer-readable storage medium having a computer program stored therein, and when the computer program is run on a computer or a processor, the computer program causes the computer or the processor to perform operations comprising:
obtaining a to-be-encoded scene audio signal comprising audio signals of C channels, wherein C is a positive integer;
performing transient detection on M channels, among the C channels, that need transient detection, to obtain transient identifiers of the M channels, wherein each transient identifier indicates whether a corresponding channel comprises a transient signal, and 1≤M≤C; and
encoding the transient identifiers of the M channels and the to-be-encoded scene audio signal to obtain a bitstream.

12. The non-transitory computer-readable storage medium according to claim 11, wherein when M=1, the M channels are a W channel among the C channels; or
when 1<M<C, the M channels are preset.

13. The non-transitory computer-readable storage medium according to claim 11, wherein performing the transient detection on the M channels, among the C channels, that need transient detection comprises:
obtaining an energy difference between a high-frequency signal and a low-frequency signal of a target channel, wherein the high-frequency signal is a signal with a frequency greater than a first threshold among audio signals of the target channel, the low-frequency signal is a signal with a frequency less than or equal to the first threshold among the audio signals of the target channel, and the target channel is one of the M channels; and
when the energy difference is greater than a second threshold, assigning a first transient identifier to the target channel, wherein the first transient identifier indicates that the target channel comprises a transient signal; or
when the energy difference is less than or equal to a second threshold, assigning a second transient identifier to the target channel, wherein the second transient identifier indicates that the target channel comprises no transient signal.

14. The non-transitory computer-readable storage medium according to claim 11, wherein the to-be-encoded scene audio signal is encoded using at least two encoding methods, and the at least two encoding methods comprise direct encoding, and further comprise at least one of spatial encoding or decorrelation.

15. The non-transitory computer-readable storage medium according to claim 14, wherein encoding the to-be-encoded scene audio signal using the at least two encoding methods comprises:
performing direct encoding on a first channel, and performing spatial encoding on a second channel; or
performing direct encoding on the first channel, and performing decorrelation on a third channel; or
performing direct encoding on the first channel, performing spatial encoding on the second channel, and performing decorrelation on the third channel;
wherein the first channel, the second channel, or the third channel is a type of channel among the C channels.
